(19) United States
(12) Patent Application Publication
(10) Pub. No.: US 2025/0174377 A1
(43) Pub. Date: May 29, 2025

(54) HIGHLY INTEGRATED HIGH-POWER RESISTOR FOR A SUSTAINED-ACTION BRAKING SYSTEM

(71) Applicant: Robert Bosch GmbH, Stuttgart (DE)

(72) Inventors: Robert Hecht, Korb (DE); Thorsten Langhorst, Karlsruhe (DE)

(21) Appl. No.: 18/959,881

(22) Filed: Nov. 26, 2024

(30) Foreign Application Priority Data
Nov. 27, 2023 (DE) 10 2023 211 813.0

(51) Int. Cl. H01C 1/08; B60L 7/02; H01C 1/02

(52) U.S. Cl. CPC H01C 1/08; B60L 7/02; H01C 1/02

(57) ABSTRACT

A highly integrated high-power resistor comprising a high-power resistor integrated into a radiator, wherein the high-power resistor is designed to efficiently dissipate heat generated during sustained-action braking operations of an sustained-action brake, having a radiator housing, a stainless steel jacket, an insulating layer and at least a first electrical high-voltage connection and a second electrical high-voltage connection, wherein at least the high-power resistor, the stainless steel jacket and the insulating layer form a high-power resistor module.

### BACKGROUND

The invention relates to a highly integrated high-power resistor comprising a high-power resistor integrated into a radiator to efficiently dissipate heat generated during sustained-action braking operations.

Due to a regulation of the United Nations Economic Commission for Europe, which has been incorporated into § 41 of the German Road Traffic Licensing Regulations (Straβenverkehrszulassungsordnung, StVZO), a sustained-action brake is required for buses with a permissible maximum mass (PMM) of more than 5.5 tons and for other motor vehicles with a permissible maximum mass of more than nice tons.

In vehicles with a conventional drivetrain based on an internal combustion engine, this is usually done by installing a hydrodynamic retarder between the transmission and the drive axis. This retarder is also considered a secondary retarder. In the case of electric utility vehicles with a permissible total weight of more than nine tons, the use of a high-power resistor integrated into the high-voltage DC circuit as an electrical consumer is an alternative for meeting the legal requirements. Using the electrical machines and the high-power resistor, the kinetic energy of the vehicle is converted into electrical energy and finally into thermal energy. However, the thermal energy (minimum requirement according to StVZO § 41 paragraph 15 is about 250 KW, depending on the driving resistance of the vehicle) must be dissipated to the environment using a coolant, electric pump, heat exchanger or radiator and electric fan, and thus has an influence on the energy efficiency and range, installation space, installation position and costs of the electric vehicle. Due to the low energy density (kWh/kg, kWh/m³) of the battery cells and the transport tasks of the utility vehicle, not any heavy (“large-volume”) energy storage devices can be installed in the commercial vehicle, which is why these vehicles must be optimized for maximum energy efficiency. Furthermore, the use of utility vehicles is highly motivated by economic factors for the entrepreneur.

### SUMMARY

According to the invention, a highly integrated high power resistor device is proposed, wherein a high power resistor is integrated into a radiator, wherein the high power resistor is designed to efficiently dissipate heat generated during sustained-action braking operations of an sustained-action brake, comprising a radiator housing, a stainless steel jacket, an insulating layer and at least a first electrical high-voltage connection and a second electrical high-voltage connection, wherein at least the high-power resistor, the stainless steel jacket and the insulating layer form a high-power resistor module.

A sustained-action brake within the meaning of the invention is a device that enables wear-free continuous braking without a reduction in braking power. For heavy utility vehicles weighing more than 5.5 tons, for example, the sustained-action brake plays a decisive role in safe and efficient driving. The sustained-action brake was specially developed for heavy utility vehicles. Their task is to cope with the increased vehicle mass and inertia. In this case, repeated braking over a longer period of time is necessary to safely control the energy generated by the high weight and to prevent the brake system from “fading”.

The proposed invention defines a high-power resistor that functions as an integral part of a continuous braking system for electrically operated brakes. This braking system with high-power resistor is used to convert kinetic energy, i.e. the energy of motion, into electrical power, and thus to brake or stop large commercial vehicles weighing more than 5.5 tons, wherein the solution proposed here can also be used for utility vehicles weighing more than nine tons. The high-power resistor is used to dissipate the electrical power generated during the sustained-action braking operations and thus prevent the service brake from overheating.

In accordance with the invention, the high-power resistor thus serves to provide an electrical resistance in the circuit. This makes it possible to control the current flow in the brake circuit and thus to finely regulate or blend the braking force between the service brakes and sustained-action brakes. In order to prevent the high-power resistor from overheating, the invention provides for the heat generated to be dissipated efficiently by integrating the high-power resistor into a radiator so that the heat generated is dissipated by the airstream.

A radiator housing is a component that encloses and protects the radiator (cooler) in a vehicle.

The solution according to the invention comprises an integration of the high-power resistor into the front area of a vehicle, whereby the high-power resistor is integrated into a special radiator. This can be stacked on the radiator package of a drivetrain component in the same way as the condenser of the air conditioning circuit. In this case, the high-power resistor integrated into the radiator is cooled by the airflow or can also be cooled, for example, by one or more electric fan impellers installed for other radiators in the front area of the vehicle.

An insulating layer within the meaning of the invention is a material separating layer that is used, for example, to prevent electrical conductivity.

In an advantageous embodiment of the highly integrated high-power resistor device proposed according to the invention, the insulation layer encloses the high-power resistor for electrical insulation at least partially, preferably completely.

The protection of the high-power resistor by the insulation layer plays an important role in sustained-action brakes. The proposed insulation layer fulfills several important functions in relation to the proposed solution. The insulating layer acts as a thermal conductor, for example, in that heat generated by the high-power resistor during the braking process is conducted and dissipated by the insulating layer. Furthermore, the insulation layer provides electrical insulation that protects the high-power resistor from any short circuits or leakage currents that may occur due to moisture or external influences, for example. In addition, the insulation layer serves, for example, as protection against mechanical damage, such as vibrations or shocks, which can affect the performance of the high-power resistor.

In an advantageous embodiment of the highly integrated high-power resistor device proposed according to the invention, the insulation layer comprises a material based on magnesium oxide.

An insulating layer containing magnesium oxide has advantages for use as an insulating layer, such as chemical resistance and mechanical strength.

In an advantageous embodiment of the highly integrated high-power resistor device proposed according to the invention, the insulation layer comprises a material based on oxide ceramic alumina.

In an advantageous embodiment of the highly integrated high-power resistor device proposed according to the invention, the insulation layer comprises a material based on aluminum nitride ceramic.

In an advantageous embodiment of the highly integrated high-power resistor proposed by the invention, the high-power resistor is at least partially enclosed by the stainless steel jacket.

A stainless steel jacket of the high-power resistor as defined by the invention has specific advantages that effectively improve the performance and lifespan of the high-power resistor. In this case, a stainless steel jacket is used primarily to effectively dissipate the heat generated by the high-power resistor. For example, this helps to prevent overheating of the high-power resistor and to regulate the operating temperature of the high-power resistor, ensuring efficient power operation. Furthermore, the stainless steel jacket comprises a corrosion-resistant material that provides excellent protection against moisture and environmental conditions that could affect the operation of the high-power resistor and its lifespan.

In an advantageous embodiment of the highly integrated high-power resistor proposed by the invention, the high-power resistor is stackable on top of a radiator package of a drivetrain component.

In an advantageous embodiment of the highly integrated high-power resistor proposed in the invention, the high-power resistor is passively cooled. Passive cooling in the sense of the invention is understood to mean a technology with which heat can be dissipated from a system without a refrigerant circuit being present.

Passive cooling of the high-power resistor in accordance with the solution according to the invention has various advantages over the more complex coolant cooling. Passive cooling using the airstream, for example, is characterized by a simple and reliable method that requires neither moving parts nor additional equipment. This significantly reduces maintenance work, which leads to cost savings. An additional advantage of passive cooling compared to more complex coolant cooling is that the cooling is independent of coolants, which minimizes potential hazards such as leaks or other defects.

In an advantageous embodiment of the highly integrated high-power resistor device proposed according to the invention, the high-power resistor is integrated into a front area of a utility vehicle, in particular into a radiator present there.

By integrating the highly integrated high-power resistor into a radiator at the front of the utility vehicle, in particular a vehicle of more than 5.5 tons, the heat of the high-power resistor is advantageously dissipated by the airflow. For example, the airflow passes around the high-power resistor during the journey, wherein, with the proposed solution of the integrated high-power resistor in the front area of the utility vehicle, the airflow effectively dissipates the heat of the high-power resistor. In this way, the airflow acts as a natural cooling mechanism, which maintains the thermal state of the high-power resistor to such an extent that the sustained-action braking system can operate efficiently. The proposed solution for a highly integrated high-power resistor is advantageously realized without additional cooling devices or energy sources and ensures a long device lifetime.

In an advantageous embodiment of the highly integrated high-power resistor proposed by the invention, the high-power resistor module is coupled to a radiator via a mechanical connection and a thermal coupling to provide an effective heat exchange area.

According to the invention, thermal coupling is to be understood, for example, as a reciprocal interaction between interconnected components, such as the radiator network and the high-power resistor, which results in an efficient exchange or transfer of heat between the components. Thus, the thermal coupling is an important component of a high-power resistor and its heat dissipation. Optimal thermal coupling enables efficient heat dissipation from the high-power resistor to the environment, maintaining a stable temperature level and avoiding overheating. The thermal coupling of the components, in particular with regard to the heat exchange area, can be achieved, for example, by connecting the high-power resistor to the radiator network over a large area, analogous to the connection of the cooling water piping of a conventional water-air radiator to the radiator network, in order to increase the heat exchange area.

Convective heat transfer by means of airflow usually results in less favorable heat transfer coefficients between metal and air than the heat transfer coefficient between metal and coolant according to the invention. In order to be able to transport the same thermal power, it is necessary to increase the heat exchange area involved in the heat exchange. According to the invention, this can be advantageously achieved by the mechanical connection, for example via a soldered joint, and the thermal coupling of the high-power resistor module with the radiator network, whereby the high-power resistor of the high-power resistor module has an effective conductivity and electrical insulation due to the magnesium oxide insulation layer and a stainless steel jacket. The radiator network describes the entirety of all fins of the radiator, for example similar to a water-air heat exchanger (“radiator”).

In an advantageous embodiment of the highly integrated high-power resistor proposed in the invention, the mechanical connection is formed as a substance-to-substance bond, in particular as a soldered joint.

As an alternative to soldered joints, mechanical connections can be made, for example, by screwing, riveting, welding, gluing or plugging, wherein the type of mechanical connection varies depending on various factors such as the type of materials to be connected, the type of stress and other specific requirements.

Furthermore, the invention relates to the use of the highly integrated high-power resistor in utility vehicles with a permissible maximum mass of more than nine tons, wherein, however, commercial vehicles of all weight classes are included.

The solution according to the invention is characterized by the fact that by integrating the high-power resistor into the radiator and dispensing with a coolant, cooling of the high-power resistor is achieved by convective cooling using airstream. This has the advantage of eliminating the need for several components that are required for cooling according to the prior art. The components that can be dispensed with include a water pump, hoses and an additional pump. Furthermore, the elimination of the components advantageously eliminates the need for electrical power, which is required for a pump, for example.

The highly integrated high-power resistor according to the invention can advantageously be integrated into a front area of the vehicle, wherein, for example, a high-power resistor can be stacked on the radiator, whereby a further saving of installation space is efficiently implemented.

The solution according to the invention is further characterized in that, in contrast to the aforementioned prior art, the highly integrated high power resistor does not require liquid cooling and can be positioned almost anywhere.

The advantageous solution according to the invention is further characterized in that the highly integrated high power resistor is provided in an sustained-action brake for utility vehicles with a permissible maximum mass of more than nine tons.

### BRIEF DESCRIPTION OF THE DRAWING

Embodiments of the invention are described in greater detail hereinafter with reference to the drawings and the subsequent description.

Shown are:

FIG. 1 a schematic illustration of a highly integrated high-power resistor.

### DETAILED DESCRIPTION

In the following description of the embodiments of the invention, identical or similar elements are denoted by identical reference signs, whereby a repeated description of these elements is omitted in individual cases. The drawings show the subject matter of the invention only schematically.

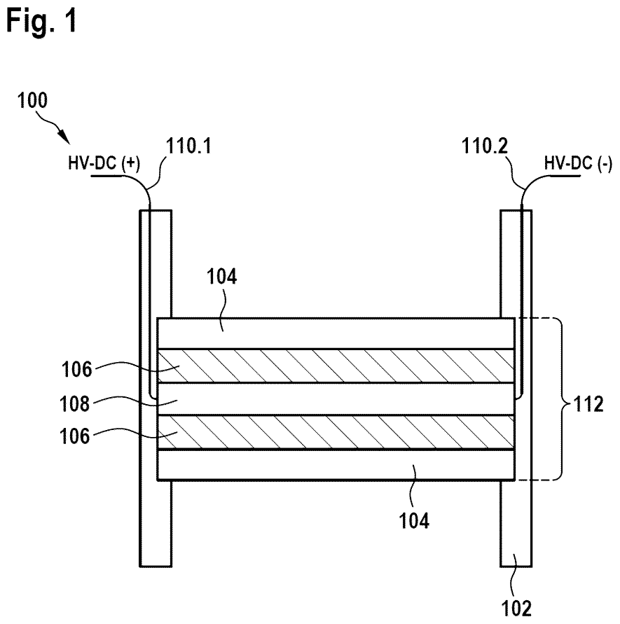

FIG. 1 is a schematic illustration of a highly integrated high-power resistor device 100 comprising a high-power resistor integrated into a radiator designed to efficiently dissipate heat generated during sustained-action braking operations, wherein the high-power resistor 108 is attached to the radiator housing 102.

FIG. 1 shows that high-power resistor 108 has a high-power resistor module 112 that is composed of several components. The high-power resistor module 112 has a high-power resistor 108, which is at least partially enclosed by an insulating layer 106, as shown in FIG. 1. Furthermore, the high-power resistor 108 enclosed by the insulating layer 106 has a further layer in the form of a stainless steel jacket 104. Furthermore, it can be seen from FIG. 1 that the high-power resistor 108 has a first electrical high-voltage connection 110.1 and a second electrical high-voltage connection 110.2.

The proposed invention, which involves at least partially enclosing the high-power resistor 108 with an insulating layer 106, preferably an insulating layer 106 made of magnesium oxide, and a noble metal jacket 104, ensures that the high-power resistor 108 has efficient conductivity and is nevertheless advantageously electrically insulated.

The highly integrated high-power resistor 100, which is integrated into a radiator, proposed according to the invention, can advantageously prevent the overheating of the sustained-action brake, wherein the highly integrated high-power resistor 100 is installed in a front region of the vehicle and is cooled by the airstream to prevent excessive heating, avoiding cooling by a coolant.

For example, the cooling of the high-power resistor 108 can be done by the airflow or alternatively using an electric fan impeller, which is installed for other radiators in the front area of the vehicle.

The highly integrated high-power resistor device 100 proposed in accordance with the invention, having at least one high-power resistor 108, is used to efficiently dissipate heat generated during sustained-action braking operations of a sustained-action brake, wherein the high-power resistor 108 is integrated into a radiator of the type preferably used in utility vehicles with a permissible maximum mass of more than nine tons, wherein utility vehicles of all weight classes are included here.

The invention is not limited to the exemplary embodiments described herein and the aspects highlighted thereby. Rather, within the range specified by the claims, a plurality of modifications is possible, which lie within the abilities of a skilled person.

1. A highly integrated high-power resistor (100) comprising a high-power resistor (108) integrated into a radiator, wherein the high-power resistor (108) is configured to dissipate heat generated during sustained-action braking operations of an sustained-action brake, having a radiator housing (102), a stainless steel jacket (104), an insulating layer (106) and at least a first electrical high-voltage connection (110.1) and a second electrical high-voltage connection (110.2), wherein at least the high-power resistor (108), the stainless steel jacket (104) and the insulating layer (106) form a high-power resistor module (112).

2. The highly integrated high-power resistor (100) according to claim 1, wherein the insulating layer (106) completely encloses the high-power resistor (108) for electrical insulation.

3. The highly integrated high-power resistor (100) according to claim 1, wherein the insulating layer (106) comprises a material based on magnesium oxide.

4. The highly integrated high-power resistor (100) according to claim 1, wherein the insulating layer (106) comprises a material based on oxide ceramic alumina.

5. The highly integrated high-power resistor (100) according to claim 1, wherein the insulating layer (106) comprises a material based on aluminum nitride ceramic.

6. The highly integrated high-power resistor (100) according to claim 1, wherein the high-power resistor (108) is at least partially enclosed by the stainless steel jacket (104).

7. The highly integrated high-power resistor (100) according to claim 1, wherein the high-power resistor (108) is stackable on a radiator package of a component of a drive train.

8. The highly integrated high-power resistor (100) according to claim 1, wherein the high-power resistor (108) is passively cooled.

9. The highly integrated high-power resistor (100) according to claim 1, wherein the high-power resistor (108) is integrated into a radiator.

10. The highly integrated high-power resistor (100) according to claim 1, wherein the high-power resistor module (112) is coupled to the radiator via a mechanical connection and a thermal coupling to provide an effective heat exchange area.

11. The highly integrated high-power resistor (100) according to claim 10, wherein the mechanical connection is configured as a substance-to-substance bond.
